(19) United States
(12) Patent Application Publication
(10) Pub. No.: US 2001/0037499 A1
(43) Pub. Date: Nov. 1, 2001

(54) Method and system for recording auxiliary audio or video signals, synchronizing the auxiliary signal with a television singnal, and transmitting the auxiliary signal over a telecommunications network

(76) Inventors: David L. Turock, Montclair, NJ (US); Richard Robbins, New York, NY (US); Warren S. Gifford, Holmdel, NJ (US)

Correspondence Address: Christopher E. Chalsen, Esq., Milbank, Tweed, Hadley & McCloy LLP, 1 Chase Manhattan Plaza, New York, NY, 10005-1413, US

(21) Appl. No.: 09/816,632

(22) Filed: Mar. 23, 2001

Related U.S. Application Data
(60) Provisional application No. 60/191,984, filed on Mar. 23, 2000.

(51) Int. Cl. H04N 7/025; H04N 7/10

(52) U.S. Cl. 725/32

(57) ABSTRACT

A method and system for recording an auxiliary signal, synchronizing the auxiliary signal with a video signal, and transmitting the auxiliary signal over a telecommunications network is provided.

The method includes receiving a video signal and generating an auxiliary signal derived at least in part from the video signal. The auxiliary signal is transmitted over a telecommunications network and the video signal is delayed as a function of the auxiliary signal. The auxiliary signal and video signal are synchronized.

To accomplish this method, a system is used which includes at least one video signal receiver, an auxiliary signal recorder, at least two telecommunications network interfaces, a signal comparator, and video signal buffer.

### BACKGROUND OF THE INVENTION

When a television signal is recorded or broadcast, it typically includes a video signal with a synchronized audio signal “attached” to it. In many cases it is desirable for a person to view the video but to be able to listen to a different audio signal. For example, the person may not speak the language of the attached audio signal, the person may be sight impaired and need a more descriptive audio interpretation, or the language in the attached audio signal may offend the person. The person may desire to see the video essentially when it is delivered or broadcast, for example, with live news coverage or a sporting event, so that they can discuss it with their friends, perhaps even in the same room.

### SUMMARY OF THE INVENTION

The present invention includes a method and system for recording an auxiliary signal, synchronizing the auxiliary signal with a video signal, and transmitting the auxiliary signal over a telecommunications network.

The method includes receiving a video signal and generating an auxiliary signal derived at least in part from the video signal. The auxiliary signal is transmitted over a telecommunications network and the video signal is delayed as a function of the auxiliary signal. The auxiliary signal and video signal are synchronized.

To accomplish this method, a system is used which includes at least one video signal receiver, an auxiliary signal recorder, at least two telecommunications network interfaces, a signal comparator, and video signal buffer.

### BRIEF DESCRIPTION OF THE DRAWINGS

FIG. 1 is a schematic illustration of a first embodiment of the method of the invention.

FIG. 2 is a schematic illustration of a second embodiment of the method of the invention.

FIG. 3 is a schematic illustration of an implementation of the methods of the invention.

### DETAILED DESCRIPTION

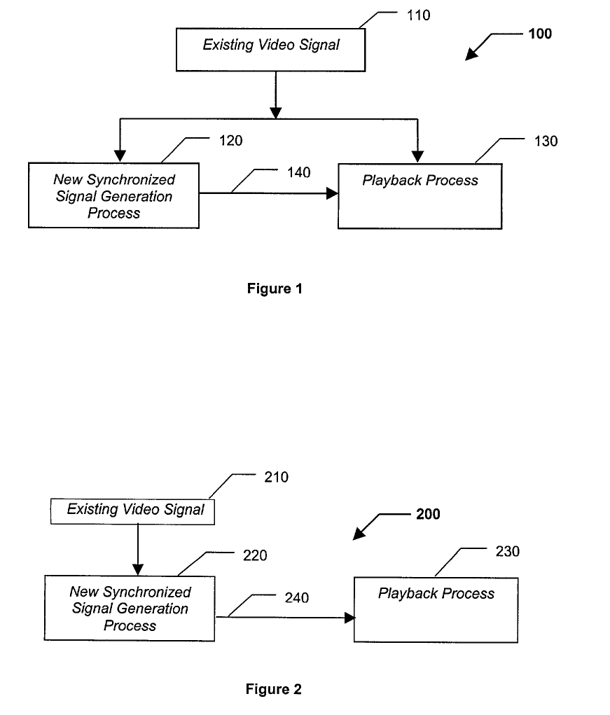

A first embodiment 100 of the method of the invention is schematically illustrated in FIG. 1. The first embodiment begins with Existing Video Signal 110. This signal is distributed to both New Synchronized Signal Generation Process 120, and Playback Process 130. In addition, the New Synchronized Signal Generation Process 120 creates New Synchronized Signal 140, which is distributed to the Playback Process 130. This embodiment applies when the playback process has access to the existing video signal at essentially the same time as the new signal generation process, for example if the existing video signal is broadcast or available on a common transmission system, such as a cable TV.

A second embodiment 200 of the method of the invention, schematically illustrated in FIG. 2, applies if the playback process does not have access to the existing video signal at essentially the same time as the new signal generation process. For example, the transmission mechanisms may be different for the two processes, or the playback process may not have access to the existing signal directly. The second embodiment also begins with an Existing Video Signal 210. This signal is distributed to the New Synchronized Signal Generation Process 220. The New Synchronized Signal Generation Process 220 creates Synchronized Combined Signal 240, which is distributed to the Playback Process 230. This signal may be in a different format from the original video signal, for example, due to different transmission media, or different technology, or to being stored and transmitted in non-real time.

The Existing Video Signal 110, 210 can be in any format, including, for example, the variety of commonly used video formats, or newly developing formats. The method can work with any video signal, any combined video and audio signal, and other formats that include video and possibly other information, such as text in a multi-media format. The signal can be “broadcast” or local, live, or recorded.

In accordance with the New Synchronized Signal Generation Process 120, 220 of the current invention, many methods of creating a new audio, and/or another other signal, to be synchronized with the video, are contemplated. One class of methods relies solely on the Existing Video Signal 110, 210. For example, a person, or even a computer, could monitor the existing video and record a new audio signal as they are monitoring. It is optional whether the combined audio signal, if it exists, is used.

Monitoring the audio signal may be required in the case of a translation of a speech which is carried in the existing video and audio signal, but may be extraneous if a completely different interpretation is being created, such as for the visually disabled.

Another class of methods may use additional information that may be available, such as a prepared text or other multi-media information available either separately from the video signal or combined with it in some way. These methods may include an automated process for generating an auxiliary signal designed to translate speech, synthesize speech if there is a prepared text, or describe the situation depicted in the video signal.

A key feature of these processes is that the generation of the synchronized signal may require that the video be paused for an interval or the viewing otherwise delayed. For example, the person or process generating the new information may need more time to describe the situation, to complete the translation, or to look up information.

Another feature is that portions of the existing video may be omitted, or otherwise processed, such as freeze-frame or slow motion, to permit better description or to omit offensive portions of the video signal. The new information signal is then marked with time stamps to correspond to the original video signal timing, and to provide the control information for playback of the video signal.

Multiple audio signals may be simultaneously prepared, for example different languages, and other information can be provided as well, including text, image, other video, etc. These can be synchronized with the original video.

The output of the New Synchronized Signal Generation Process 120, 220 depends on whether the Playback Process 130, 230 is receiving the Existing Video Signal 110, 210 in nearly real time with the New Synchronized Signal Generation Process 120, 220.

In the first embodiment, the Existing Video Signal 110 is available to the Playback Process 130 directly. The New Synchronized Signal 140 need only contain the new information, the synchronizing information, and any playback control information, for proper playback.

In the second embodiment, the Existing Video Signal 210 is not directly the available to the Playback Process 230. The New Signal 240, containing the new information as well as synchronizing and playback control information, can be either (1) combined with a representation of the existing video signal for distribution to the Playback Process 230, or (2) a video and audio delivery format can be used and sent separately over the telecommunications network.

The Playback Process 130, 230 takes the inputs and generates a combined experience for the viewer. The viewer should see a fully synchronized signal with the audio and other descriptions corresponding to the video.

In the first embodiment 100, the Playback Process 130 has the ability to buffer the video and audio, and other signals, independently so that they can be synchronized and to execute the commands specified in the New Synchronized Signal Generation Process 120. The Playback Process 130 can run on a PC or other device that synchronizes the audio and video and other signals, and executes the specified commands. In the second embodiment, the Synchronized Combined Signal 140 can be either a combined video and audio signal, for example, a conventional television format, or it can be the same information as the New Synchronized Signal 240 plus a video signal in any format. In the former case, the Playback Process 230 can simply be any compatible video and audio display system, for example, a TV set. In the latter case, the same functions are required in the Playback Process 230 as in the first embodiment 100. The viewer will also have control over the playing of the combined and individual signals, for example, pause and replay.

There may be several synchronized audio signals to choose from, for example, different languages. There may be other types of signals provided, such as text, images and other video signals that the viewer can select and control. The viewer may have a convenient, easy-to-use interface to control the playback and to select the various options and operate the controls. The system may interface with standard video and audio displays and recording systems.

The New Synchronized Signal 140 may include an audio signal, a set of time stamps or other signals to allow the playback process to synchronize the audio and other signals with the video, control signals to instruct the Playback process in how to act on the other signals, or other types of information, such as text, graphics, images, or other video. The signal 140 is sent as a combined package of information so that the Playback Process 130 can receive it, decode the various components, synchronize with the Existing Video Signal 110, and carry out the functions as specified in the New Synchronized Signal Generation Process 120.

The Synchronized Combined Signal 240 contains the same functional information as the New Synchronized Signal 140, but in addition includes the video signal itself, although possibly in a different format from the original video signal. The combined signal 240 may be delivered in a conventional video format so that it can be played on any compatible audio and video system. The advantage is the ability to use existing standards and media and receiving and display devices.

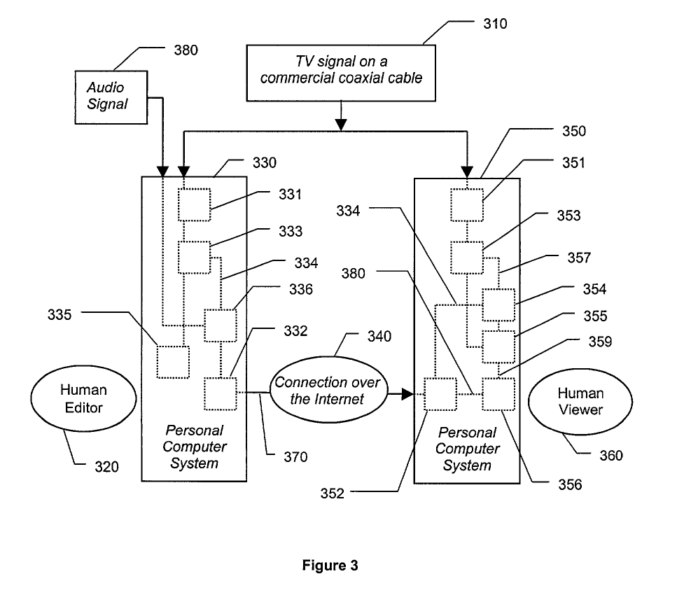

A schematic illustration of an implementation of the methods of the invention is shown in FIG. 3. There are many different systems, devices, and configurations that can be used to implement the proposed method. The system of this implementation includes a standard TV signal 310 sent over a commercial coaxial cable. This TV signal 310 is delivered to two Personal Computer (“PC”) systems 330, 350. Each PC system 330, 350 is equipped with a video signal receiver 331, 351 and an Internet interface 332, 352. The two PC Systems 330, 350 are connected together over the Internet 340.

PC system 330 takes the incoming TV signal 310 and derives 333 a synchronizing signal 334 that can specify a precise instant in the TV signal time stream, namely the clock time associated with receipt of the video signal. PC system 330 displays the TV signal 310 on a portion of its monitor 335. A human editor 320 views this TV signal 310 and records a new audio signal 380 to be synchronized with the TV signal. The human editor 320 can control the time stamps on the new audio signal, for example delaying the clock time to give the human editor 320 time to think. Thus, the new audio signal may cause the video to be delayed from actual clock time in playback time. This new audio signal 380 as well as the synchronizing signal 334 is coded 336 and transmitted 370 over the Internet 390 to PC system 350.

PC system 350 receives the TV signal 310 and derives 353 clock time signal 357 from it. PC system 350 also receives the combined signal 370 including synchronizing signal 334 and linked new audio signal 380 over the Internet connection 352 from PC system 330. PC system 350 now compares 354 the two time-stamp signals 334, 357 and buffers 355 the incoming TV signal so that it matches the synchronizing timing signal 334 coming over the Internet connection 352. PC system 350 then displays 356 to the viewer 360 the delayed TV signal 359 synchronized with the new audio signal 380. Thus the viewer 360 perceives that the TV signal has the new audio signal seamlessly integrated with it.

This implementation also provides many other capabilities. The human editor 320, who can actually be more than one person, may control the display of the TV signal. For example, the video signal may be paused for a specified period of time, viewed in slow motion, or speeded up. These effects are then replicated by PC system 350 so that human viewer 360 perceives the video and audio signals as directed by the human editor. Similarly, human viewer 350 may control the playback of the signal, much as they would from a VCR or other recorded audio and video source. Thus, human viewer 360 may pause, speed up, slowdown, or replay the derived audio and video signal. More advanced capabilities can also be provided, such as zooming in or out on the video image, special effects, such as transitions from one image to another, and myriad other capabilities which are becoming available in video playback systems and on personal computers. Human editor 360 can also add an additional video or other signals 380, for example, an image of the human editor 320. A signal containing this additional information 370 is transmitted over the Internet connection 340 to PC system 350. Additional information and control information, such as music, subtitles, text, still images, other audio and video, etc. can also be added and synchronized. A further extension is to allow two or more TV signals to be combined and otherwise controlled by the human editor during preparation of new information, and by the human viewer during playback. Thus this implementation, and more generally the method, can take one or more existing media and create a variety of new media from this under the control of both the human editor and human viewer.

It will be understood that the above-described embodiments are merely illustrative of the principles of the invention and that other arrangements may be devised by those skilled in the art without departing from the spirit and scope of the invention.

What is claimed is:

1. A system for recording an auxiliary signal, synchronizing the auxiliary signal with a video signal, and transmitting the auxiliary signal over a telecommunications network comprising a first video signal receiver, an auxiliary signal recorder, a first telecommunications network interface; a second telecommunications network interface, a signal comparator, and a video signal buffer.

2. The system of claim 1 further comprising a first computer and a second computer.

3. The system of claim 2 wherein said first computer includes said first video signal receiver, said auxiliary signal recorder, said first telecommunications network interface, said signal comparator, and said video signal buffer, and said second computer includes said second telecommunications network interface.

4. The system of claim 2 wherein said first computer includes said first video signal receiver, said auxiliary signal recorder, and said first telecommunications network interface, and said second computer includes said second telecommunications network interface, said signal comparator, said video signal buffer, and a second video signal receiver.

5. The system of claim 1 wherein the auxiliary signal includes an audio signal.

6. The system of claim 1 wherein the auxiliary signal includes a video signal.

7. The system of claim 2 wherein one of said first and second computers further includes a video signal speed controller.

8. The system of claim 2 wherein one of said first and second computers further includes an image size controller.

9. The system of claim 2 wherein one of said first and second computers further includes a video signal clock signal deriver.

10. The system of claim 1 wherein one of said first and second telecommunications network interfaces is an Internet interface.

11. The system of claim 1 wherein said signal comparator is a clock signal comparator.

12. A system for recording an auxiliary signal, synchronizing the auxiliary signal with a video signal, and transmitting the auxiliary signal over a telecommunications network comprising:
a first computer, said first computer having means for recording the auxiliary signal, means for receiving the video signal, means for deriving a synchronizing signal from the video signal, and means for transmitting the auxiliary signal over the telecommunications network; and
a second computer, said second computer having means for receiving the auxiliary signal and the synchronizing signal from the telecommunications network, means for receiving the video signal, and means for synchronizing the auxiliary signal and the synchronizing signal with the video signal to form an integrated combined signal.

13. A method for recording an auxiliary signal, synchronizing the auxiliary signal with a video signal, and transmitting the auxiliary signal over a telecommunication network comprising the steps of:
receiving the video signal;
generating the auxiliary signal, the auxiliary signal derived at least in part from said video signal;
transmitting the auxiliary signal over the telecommunications network;
receiving the auxiliary signal;
delaying the video signal as a function of said auxiliary signal; and
synchronizing the video signal with the auxiliary signal.

14. The method of claim 13 wherein said video signal receiving, auxiliary signal generating, video signal delaying, auxiliary signal transmitting, and synchronizing steps are performed with a first computer, and said auxiliary signal receiving step is performed using a second computer.

15. The method of claim 13 wherein said video signal receiving, auxiliary signal generating, and auxiliary signal transmitting steps are performed using a first computer, and said auxiliary signal receiving, video signal delaying, and synchronizing steps are performed using a second computer.

16. The method of claim 15 further including the step of receiving the video signal using said second computer.

17. The method of claim 13 wherein said generating step further includes deriving a first synchronizing signal from the video signal.

18. the method of claim 17 wherein said delaying step further includes deriving a second synchronizing signal from the video signal and comparing said first and second synchronizing signals.

19. The method of claim 13 in which the auxiliary signal is an audio signal.

20. The method of claim 13 further including the step of playing said synchronized video and auxiliary signals using a computer.
